(19) United States
(12) Patent Application Publication
(10) Pub. No.: US 2026/0333140 A1
(43) Pub. Date: Oct. 22, 2026

(54) SIGNALING SEAMLESS ROAMING AKMS AND KEY MANAGEMENT HIERARCHY

(71) Applicant: Cisco Technology, Inc., San Jose, CA (US)

(72) Inventors: Binita GUPTA, San Diego, CA (US); Stephen M. ORR, Wallkill, NY (US); Brian D. HART, Sunnyvale, CA (US)

(21) Appl. No.: 19/468,902

(22) Filed: Feb. 3, 2026

Related U.S. Application Data
(60) Provisional application No. 63/754,427, filed on Feb. 5, 2025.

(51) Int. Cl. H04W 36/00; H04W 12/04; H04W 12/06; H04W 36/18

(52) U.S. Cl. CPC H04W 36/0038; H04W 12/04; H04W 12/06; H04W 36/18

(57) ABSTRACT

The present disclosure provides techniques for seamless roaming and key management in wireless networks, including transmitting, by an access point (AP), one or more management frames advertising support for seamless roaming, the one or more management frames comprising information identifying one or more authentication and key management (AKM) options supported for seamless roaming, receiving, by the AP, an authentication frame from a station (STA), the authentication frame indicating selection of an authentication mechanism and an AKM option for seamless roaming, completing, by the AP, authentication of the STA using the selected authentication mechanism and the selected AKM option, receiving, by the AP, an association request frame from the STA, the association request frame comprising information identifying the selected AKM option for seamless roaming, and establishing, by the AP, a seamless roaming key hierarchy for the STA based on the selected AKM option.

### CROSS-REFERENCE TO RELATED APPLICATIONS

This application claims benefit of co-pending United States provisional patent application Serial No. 63/754,427 filed Feb. 5, 2025. The aforementioned related patent application is herein incorporated by reference in its entirety.

### TECHNICAL FIELD

Embodiments presented in this disclosure generally relate to wireless communications. More specifically, embodiments disclosed herein relate to seamless roaming and key management in wireless networks.

### BACKGROUND

Recent developments in the IEEE 802.11bn standard have proposed support for a seamless mobility domain (SMD) to enable improved roaming performance in wireless local area networks (WLANs). An SMD includes multiple access point multi-link devices (AP MLDs) and a client or non-AP multi-link device that associates with an SMD management entity (SMD-ME). Once associated with the SMD-ME, the client may roam among AP MLDs within the SMD without performing a reassociation procedure for each transition. In this architecture, the client may establish a single pairwise master key security association (PMKSA) and a single pairwise transient key security association (PTKSA) with the SMD-ME.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example wireless communication environment, according to some embodiments of the present disclosure.

FIG. 2 depicts an example signaling framework for seamless roaming authentication and key management, according to some embodiments of the present disclosure.

FIG. 3 depicts an example set of authentication and key management (AKM) suite selectors defined for seamless roaming, according to some embodiments of the present disclosure.

FIG. 4 depicts an example set of authentication and key management (AKM) suite selectors corresponding to a hybrid seamless roaming key management mode, according to some embodiments of the present disclosure.

FIG. 5A depicts an example set of authentication and key management (AKM) suite selectors defined for seamless roaming, according to some embodiments of the present disclosure.

FIG. 5B depicts example formats of signaling seamless roaming key management modes using one or more separate fields, according to some embodiments of the present disclosure.

FIG. 6 depicts an example sequence of interactions and management frame exchanges between a station multi-link device (STA MLD) and an access point multi-link device (AP MLD), according to some embodiments of the present disclosure.

FIG. 7 depicts an example method for negotiating seamless roaming authentication and key management behavior within a seamless mobility domain (SMD), according to some embodiments of the present disclosure.

FIG. 8 depicts an example method for negotiating seamless roaming authentication and key management behavior within an SMD, according to some embodiments of the present disclosure.

FIG. 9 is a block diagram depicting an example seamless roaming negotiation method, according to some embodiments of the present disclosure.

FIG. 10 depicts an example network device configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure introduces a method, including transmitting, by an access point (AP), one or more management frames advertising support for seamless roaming, the one or more management frames comprising information identifying one or more authentication mechanisms and one or more key management options supported for seamless roaming, receiving, by the AP, an authentication frame from a station (STA), the authentication frame indicating selection of an authentication mechanism and a key management option for seamless roaming, completing, by the AP, authentication of the STA using the selected authentication mechanism, receiving, by the AP, an association request frame from the STA, the association request frame comprising information identifying the selected key management option for seamless roaming, and establishing, by the AP, a seamless roaming key hierarchy based on the selected key management option.

Other embodiments in this disclosure provide a computer program product comprising one or more computer-readable storage media collectively containing computer-readable program code that, when executed by operation of one or more computer processors, performs operations in accordance with one or more of the above methods, and a system of a network device comprising one or more computer processors, and one or more memories collectively containing one or more programs, which, when executed by the one or more computer processors, perform operations in accordance with one or more of the above methods.

### Example Embodiments

In recent wireless local area network (WLAN) architectures, a seamless mobility domain (SMD) has been proposed to support improved mobility performance. An SMD includes a plurality of access point multi-link devices (AP MLDs) that collectively provide wireless coverage within the domain. A client or a non-AP multi-link device (non-AP MLD) may associate with an SMD management entity (SMD-ME) via one of the access points (APs). Once connected, the client may roam between AP MLDs within the SMD without performing a reassociation procedure as it moves within the mobility domain.

In an SMD-based architecture, the client may establish a single pairwise master key security association (PMKSA) and a single pairwise transient key security association (PTKSA) with the SMD-ME. These security associations provide the basis for secure communication as the client roams among AP MLDs within the SMD.

For enterprise deployments, it is often desirable to reuse the same pairwise transient key (PTK) as the client moves within the SMD, to not require regenerating a new PTK for every roam. In such cases, AP MLDs within the SMD may establish secure communication channels among themselves, through which PTK material can be shared securely. Reuse of the shared PTK across AP MLDs provides several benefits, including reduced roaming latency, improved support for last-minute or panic roaming events, secured forwarding of traffic to a target AP during roaming, and improved scalability in high-density roaming environments by avoiding frequent PTK generation.

In contrast, some client implementations or deployment scenarios may prefer generation of a different PTK when the client roams to a target AP MLD. For example, in residential or less tightly controlled environments, APs within an SMD may not be trusted to securely manage or share the same PTK. In such cases, the SMD may support a mode where different PTKs are generated for each AP MLD in the SMD, to provide per-AP key isolation.

Embodiments of the present disclosure provide methods, systems, and apparatuses for signaling and negotiating seamless roaming key management behavior within an SMD. More specifically, the disclosed embodiments enable the SMD-ME or AP MLDs within an SMD to signal the key hierarchy supported for seamless roaming, including whether a single PTK is reused across AP MLDs, whether different PTKs are generated for different AP MLDs, or whether a hybrid mode is supported. Based on the signaling, a client device can determine the appropriate roaming behavior when transitioning between AP MLDs, such as reusing an existing PTK, generating a new PTK for a target AP, or a hybrid approach (e.g., temporarily reusing a previously generated PTK followed by PTK regeneration after the roaming).

The disclosed signaling and negotiation mechanisms allow the SMD to flexibly support a range of deployment scenarios and client capabilities and maintain efficient and secure roaming behavior.

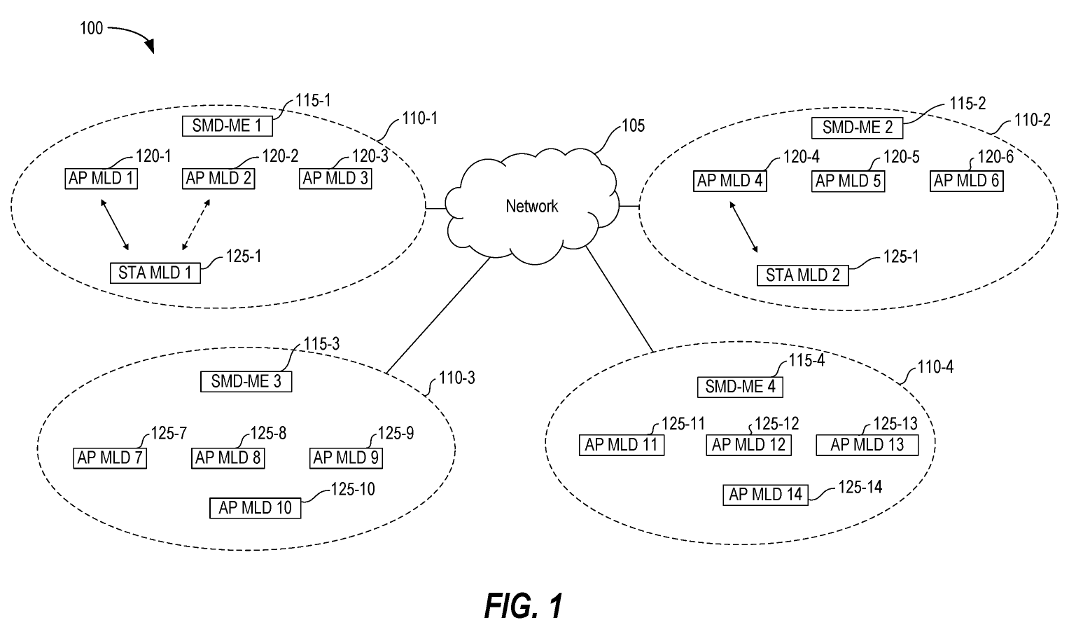

FIG. 1 depicts an example wireless communication environment 100 including a network 105 and multiple seamless mobility domains (SMDs) 110-1 through 110-4. Each SMD 110 represents a logical mobility domain within which a station (STA) may roam among multiple access point multi-link devices (AP MLDs) without performing reassociation or reauthentication procedures for each roaming.

As shown, SMD 110-1 includes an SMD management entity (SMD-ME 1) 115-1 and a plurality of AP MLDs, including AP MLD 1 (120-1), AP MLD 2 (120-2), and AP MLD 3 (120-3). A station multi-link device (STA MLD) 125-1 is associated with SMD-ME 1 (115-1) and connected with AP MLD 1 (120-1) and may roam within SMD 110-1, for example, from AP MLD 1 (120-1) to AP MLD 2 (120-2), without performing a reassociation procedure or a full reauthentication exchange. STA MLD 1 (125-1) performs authentication and association with SMD-ME 1 (115-1), and the resulting security context is maintained as the STA MLD 1 (125-1) roams among AP MLDs 120 within the same SMD 110.

As illustrated, SMD 2 (110-2) includes SMD-ME 2 (115-2) and AP MLD 4 (120-4), AP MLD 5 (120-5), and AP MLD 6 (120-6), with STA MLD 2 (125-2) shown as associated with SMD-ME 2 (115-2) and connected with AP MLD 4 (120-4). SMD 3 (110-3) includes SMD-ME 3 (115-3) and AP MLDs 125-7 through 125-10, and SMD 4 (110-4) includes SMD-ME 4 (115-4) and AP MLDs 125-11 through 125-14. Each SMD 110 operates independently, and roaming without reassociation is supported within the boundaries of a given SMD.

In the illustrated example 100, an STA MLD 125-1 that associates with an SMD-ME 115 may establish a single PMKSA and a single PTKSA with the SMD-ME 115. Within an SMD, different roaming key management behaviors or modes may be supported. In some embodiments, such as enterprise deployments, the same pairwise transient key (PTK) may be reused as the STA MLD 125-1 roams among AP MLDs within the SMD. In such configurations, AP MLDs without the SMD may maintain secure communication channels that allow PTK to be shared securely between AP MLDs on an SMD. This approach reduces roaming latency and improves scalability. In some embodiments, such as residential or less trusted environments, different PTKs may be generated for different AP MLDs within the same SMD 110. In some embodiments, a hybrid mode may be supported, where reuse of a previously established PTK is permitted during roaming, followed by generation of a new PTK for a target AP MLD after the transition.

Different AP MLDs 120 or SMD-MEs 115 may support different authentication and seamless roaming key management modes, and different STA MLDs may also support different modes. Embodiments of the present disclosure introduce mechanisms by which AP MLDs, SMD-MEs, and STA MLDs signal and negotiate supported authentication and key management behavior for seamless roaming. Through such signaling and negotiation, the entities may select whether a single-PTK mode, a different-PTK mode, or a hybrid mode is used within a given SMD. The bidirectional negotiation enables interoperable and efficient roaming behavior.

Although the SMD-ME 115 is illustrated as a separate logical entity, the SMD-ME functions may be implemented on the AP MLDs within the SMD, on a wireless local area network (WLAN) controller (WLC), or on any network devices coupled to the AP MLDs 120 via network 105 and configured to manage authentication and key management coordination for the SMD.

The number and arrangement of AP MLDs and STA MLDs are provided for conceptual clarity. In some embodiments, an SMD 110 may include any number of APs (including one). Although the APs are illustrated as AP MLDs in FIG. 1, in some embodiments, one or more APs within an SMD may be implemented as single-link APs. Similarly, although the STAs are illustrated as STA MLDs, an STA may be implemented as a single-link STA.

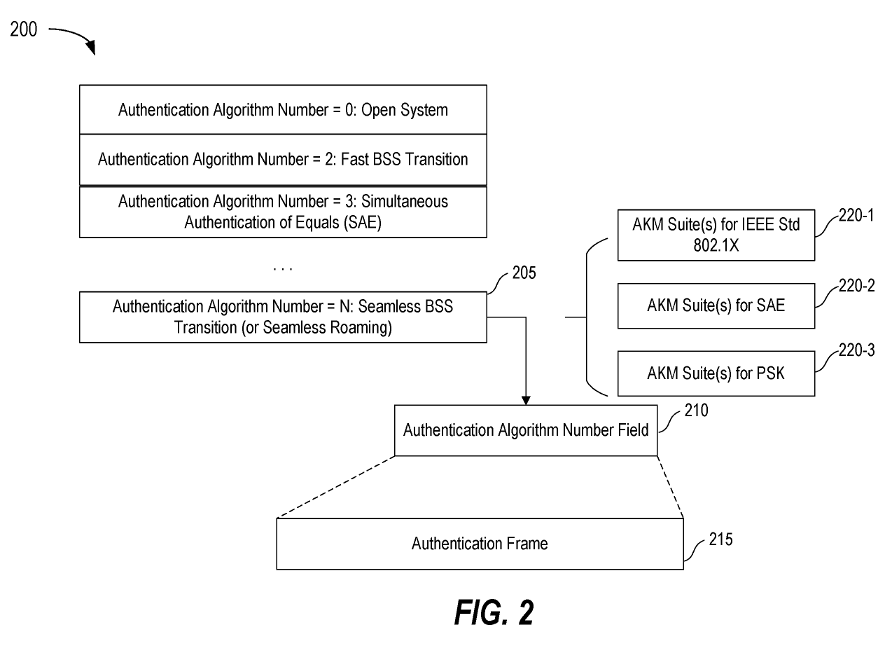

FIG. 2 depicts an example signaling framework 200 for seamless roaming authentication and key management. In the depicted example 200, a new authentication algorithm number (AAN) 205 and associated Authentication and Key Management (AKM) suites 220 are defined.

In the depicted example, existing AANs are shown for reference, including AAN = 0 corresponding to an open system authentication mechanism, AAN = 2 corresponding to fast basic service set (BSS) transition authentication, and AAN = 3 corresponding to simultaneous authentication of equals (SAE). In addition to these existing values, embodiments of the present disclosure define a new AAN 205, for example, AAN = <value N> (where N can be any unused AAN number), corresponding to seamless roaming or seamless BSS transition authentication.

The newly defined AAN 205 (e.g., AAN = <value N> for seamless roaming) is included in the authentication algorithm number field 210 of an authentication frame 215 exchanged between an STA and the network. In some embodiments, the AAN is included in an authentication frame transmitted by an STA and confirmed or echoed in an authentication frame (sent in response) transmitted by an AP or SMD-ME. Use of the new AAN explicitly indicates that the authentication exchange is associated with seamless roaming within an SMD.

As depicted, a plurality of new AKM suites 220 may be defined for seamless roaming. These AKM suites 220 specify the authentication and key management behavior to be used for seamless roaming. In some embodiments, different AKM suites are defined for different authentication types. For example, AKM suites 220-1 may correspond to an authentication type based on IEEE 802.1X, AKM suites 220-2 may correspond to an authentication type based on SAE, and AKM suites 220-3 may correspond to an authentication type based on a pre-shared key (PSK).

In addition, in some embodiments, separate AKM suites may be defined to distinguish different seamless roaming key management modes under a given authentication type. For example, under an IEEE 802.1X authentication type, a first AKM suite may be used to indicate support for reuse of a single PTK across AP MLDs within an SMD, while a second AKM suite may be used to indicate support for the generation of different PTKs for different APs within the same SMD. In some embodiments, additional AKM suites may be defined to indicate hybrid roaming key management behavior, where reuse of a previously established PTK is permitted during roaming and generation of a new PTK may occur after roaming.

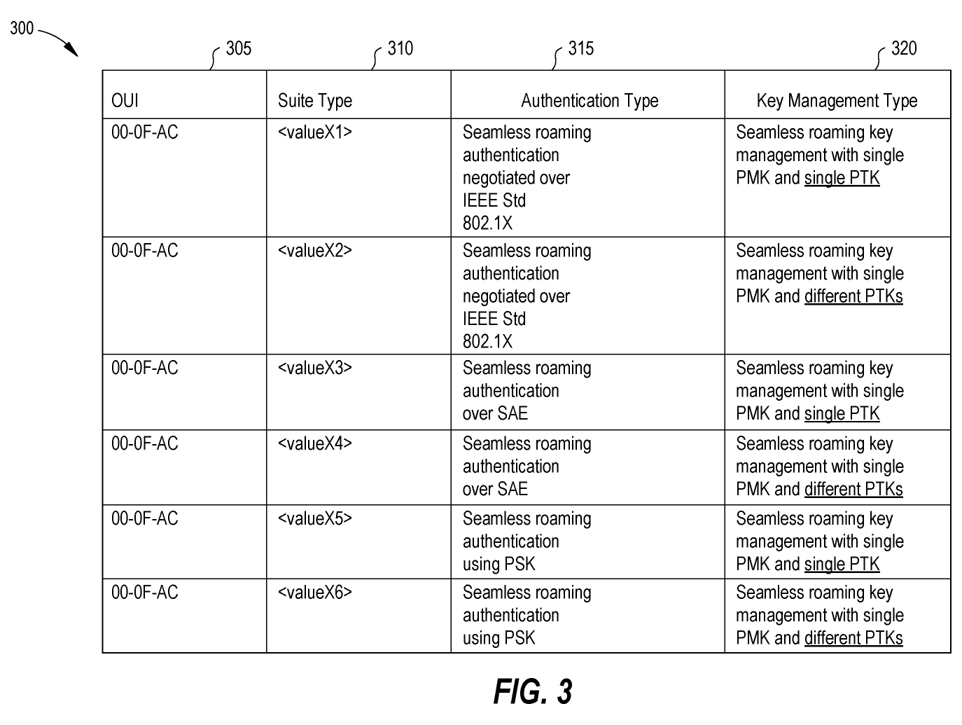

The AKM suites defined for seamless roaming may be advertised by an AP or an SMD-ME in one or more management frames, such as beacon frames or probe response frames. Upon receiving the advertised AKM suites, a client device may determine a set of authentication and key management options supported by both the client device and the SMD network, select an appropriate seamless roaming authentication and key management option from the determined set, and include information identifying the selected option in one or more authentication and association-related management frames (e.g., authentication frame, (re)association request or response). Based on the selected authentication and key management option, the AP and the STA establish a seamless roaming security context for use as the STA roams within the SMD. More details about the example AKM suites defined for seamless roaming are discussed below with reference to FIG. 3.

FIG. 3 depicts an example set 300 of authentication and key management (AKM) suite selectors defined for seamless roaming, according to some embodiments of the present disclosure. The AKM suites as shown may be used with the newly defined AAN (e.g., AAN = <value N>) for seamless roaming discussed above with reference to FIG. 2, or may be used with one or more existing AANs without defining a new AAN for use in authentication frames.

As depicted, the AKM suite selectors are represented in a table format that includes four columns. Column 305 identifies an organizationally unique identifier (OUI) associated with each AKM suite selector. Column 310 identifies a suite type value that uniquely distinguishes each AKM suite. As used herein, the suite type value <valueXn> corresponds to an unused value for an AKM suite type in the current standards. Column 315 identifies an authentication type associated with the AKM suites, and column 320 identifies a key management type applicable to the AKM suite.

Each row of the table corresponds to a respective AKM suite defined for seamless roaming. In the illustrated example, a first AKM suite (e.g., suite type <valueX1>) corresponds to seamless roaming authentication negotiated over IEEE 802.1X and indicates a key management mode, where a single PMK and a single PTK are used within an SMD. A second AKM suite (e.g., suite type <valueX2>) also corresponds to seamless roaming authentication negotiated over IEEE 802.1X but indicates a different key management mode, where a single PMK is used and different PTKs are generated for different AP MLDs within the SMD.

Additional AKM suites shown in FIG. 3 correspond to other authentication types. For example, a third AKM suite (e.g., suite type <valueX3>) corresponds to seamless roaming authentication over SAE and indicates a key management mode using a single PMK and a single PTK, and a fourth AKM suite (e.g., suite type <valueX4>) corresponds to seamless roaming authentication over SAE and indicates a key management mode using a single PMK and different PTKs. A fifth AKM suite (e.g., suite type <valueX5>) corresponds to seamless roaming authentication using a PSK and indicates a single-PMK, single-PTK key management mode, and a sixth AKM suite (e.g., suite type <valueX6>) corresponds to seamless roaming authentication using PSK and indicates a key management mode using a single-PTK, different-PTKs.

In some embodiments, the key derivation type associated with each AKM suite may use any key derivation functions already defined in the IEEE 802.11 baseline specifications or any newly defined key derivation function. The specific key derivation function used for each AKM suite is defined by the AKM suite definition.

In real-time operations, an AP (e.g., AP MLD 1 in FIG. 1) or an SMD-ME (e.g., SMD-ME 1 in FIG. 1) may advertise one or more of the AKM suites using robust security network elements included in management frames (e.g., beacons or probe responses). For example, the AKMs for seamless roaming can be advertised in a Robust Security Network Element (RSNE), a Robust Security Network (RSN) Override element, or a new element defined for Ultra High Reliability (UHR) that carries security parameters. A STA (e.g., STA MLD 1 in FIG. 1) receiving the advertised AKM suites may determine which authentication types and seamless roaming key management modes are supported by both the STA and the network. The client device then selects an appropriate AKM suite and indicates the selected AKM suite in authentication- and association-related frames (e.g., authentication frame and (re)association request or response). Based on the selected AKM suite, the STA and network perform authentication and establish a roaming key hierarchy corresponding to the indicated authentication type and key management mode.

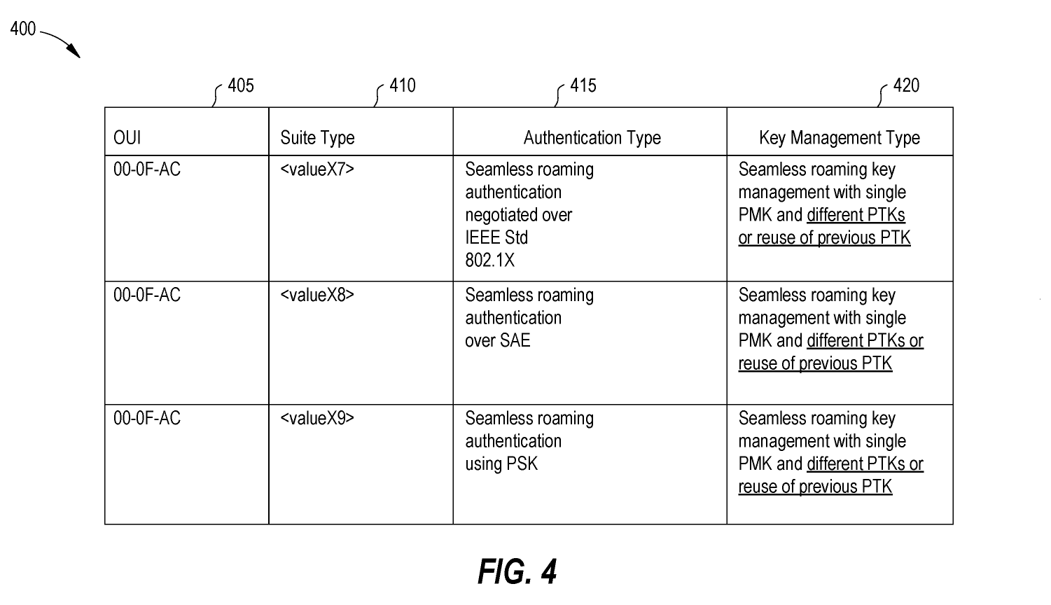

The embodiments illustrated in FIG. 3 enable flexible support for reuse of a single PTK or generation of different PTKs across different authentication types within an SMD. In some embodiments, additional AKM suites may be defined to indicate a hybrid key management mode, where generation of different PTKs and reuse of a previously established PTK are both supported. Additional details regarding example AKMs and associated key management modes are discussed below with reference to FIG. 4.

FIG. 4 depicts an example set 400 of authentication and key management (AKM) suite selectors corresponding to a hybrid seamless roaming key management mode, according to some embodiments of the present disclosure.

The AKM suites shown here represent additional AKM suites that are defined to support flexible roaming behavior, where an STA may either generate different PTKs for different APs within an SMD or reuse a previously established PTK during roaming, and then generate a new PTK after roaming.

As depicted, the AKM suite selectors are presented in a table format. Column 405 identifies an OUI associated with the AKM suites, and column 410 identifies a suite type value that distinguishes each AKM suite. As used herein, the suite type value <valueXn> corresponds to an unused value for an AKM suite type within the current standards. Column 415 identifies an authentication type associated with the AKM suites, and column 420 identifies a key management type applicable to the AKM suite.

Each row of the table corresponds to a respective AKM suite supporting the hybrid seamless roaming key management mode. In a first row, an AKM suite (e.g., suite type <valueX7>) corresponds to seamless roaming authentication negotiated over IEEE 802.1X and indicates a key management mode, where a single PMK is used and either different PTKs may be generated for different AP MLDs within the SMD or a previously established PTK may be reused during roaming. In a second row, an AKM suite (e.g., suite type <valueX8>) corresponds to seamless roaming authentication over SAE and similarly indicates support for a hybrid key management mode permitting either generation of different PTKs or reuse of a previously established PTK during roaming. In a third row, an AKM suite (e.g., suite type <valueX9>) corresponds to seamless roaming authentication using a PSK and indicates support for the hybrid key management behavior.

In some embodiments, the key derivation type associated with each hybrid AKM suite may use any key derivation function already defined in the IEEE 802.11 baseline specifications or any newly defined key derivation function. The specific key derivation function used is specified per AKM suite definition.

The hybrid seamless key management mode enables a network to allow generation of a different PTK for a target AP MLD when conditions permit, while also allowing reuse of a previously established PTK from a serving AP MLD when rapid roaming is desired (or required). This hybrid mode may be useful when a client does not have sufficient time to generate a new PTK prior to roaming to a target AP MLD. In such configurations, the client may initially reuse the existing PTK to establish secure communication with the target AP MLD and, after roaming, perform a PTK rekeying procedure to generate a different PTK for continued operation.

The AKM suites depicted in FIG. 4 for supporting the hybrid key management mode may be used in combination with the AKM suites depicted in FIG. 3, and such AKM suites may be associated with a newly defined AAN for seamless roaming (e.g., AAN = <value N> in FIG. 2) or with one or more existing AANs used in authentication frames.

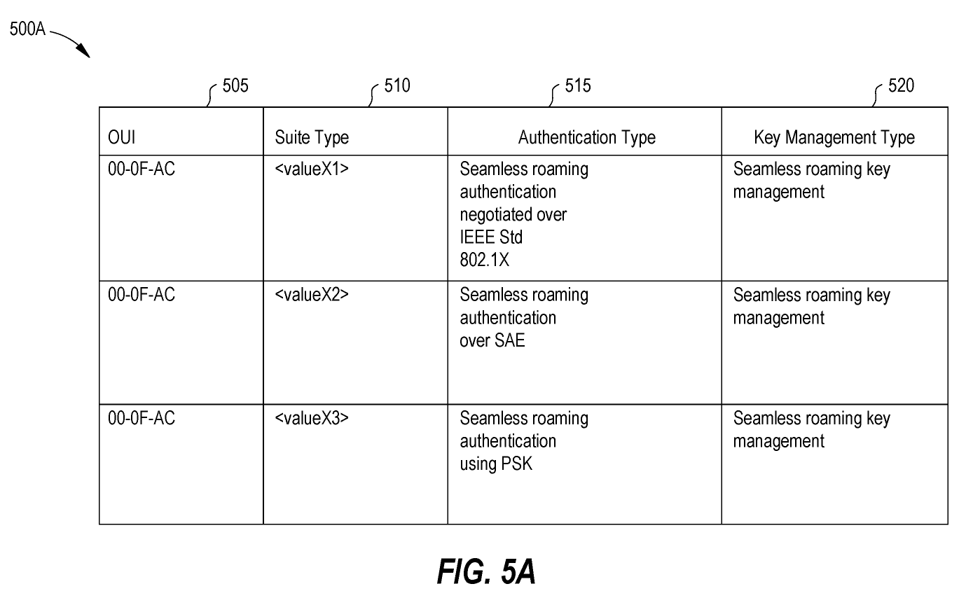

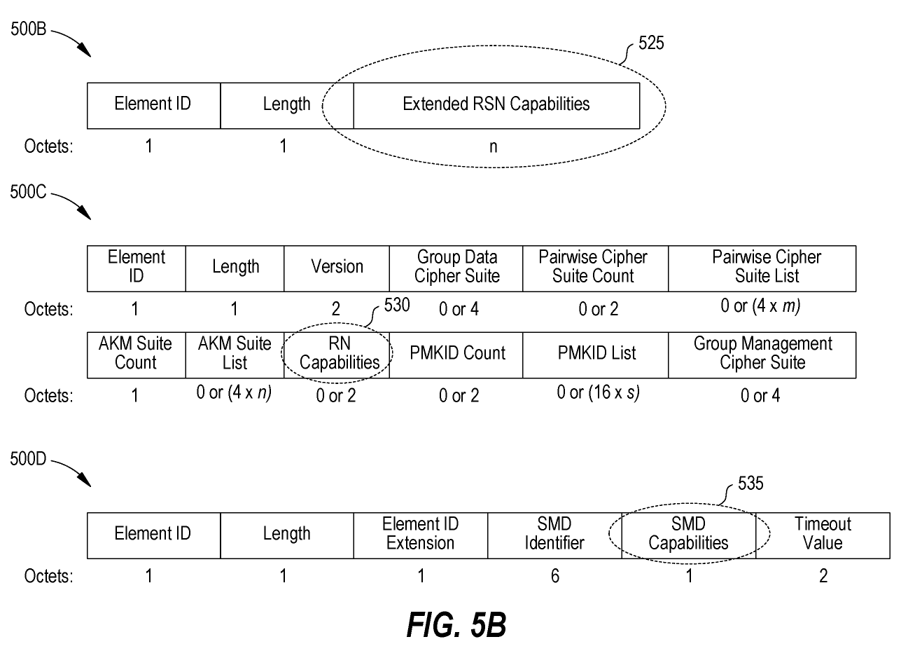

FIG. 5A depicts an example set 500A of authentication and key management (AKM) suite selectors defined for seamless roaming, according to some embodiments of the present disclosure.

In addition to AKM suites that are defined explicitly to indicate different seamless roaming key management modes, as depicted in FIGS. 3 and 4, the AKM suites shown in FIG. 5A are defined to identify the authentication type used for seamless roaming, and the specific seamless roaming key management behavior indicating reuse of a single PTK across AP MLDs of an SMD, or generation of different PTKs for different AP MLDs of an SMD, or a hybrid mode (as described above) is indicated using one or more separate signaling fields by the AP. These signaling fields may be carried independently of the AKM suite signaling, as discussed in further detail with reference to FIG. 5B.

As depicted, the example AKM suite selectors for seamless roaming are illustrated in a table format. The table includes four columns, where column 505 identifies an OUI, column 510 identifies a suite type value, column 515 identifies an authentication type, and column 520 identifies a key management type. In this embodiment, the key management type associated with each AKM suite broadly indicates “seamless roaming key management,” without distinguishing between single-PTK, different-PTK, or hybrid modes. As used herein, each suite type value <valueXn> corresponds to any unused value for an authentication and key management suite type within the current standards.

In the example, a first AKM suite (e.g., suite type <valueX1>) corresponds to seamless roaming authentication negotiated over IEEE 802.1X, a second AKM suite (e.g., suite type <valueX2>) corresponds to seamless roaming authentication over SAE, and a third AKM suite (e.g., suite type <valueX3>) corresponds to seamless roaming authentication using a PSK. Each of these AKM suites identifies an authentication type for seamless roaming but does not, by itself, specify whether a single PTK, different PTKs, or a hybrid key management mode is used.

In some embodiments, the existing AKM suites already defined or new AKMs that get defined (e.g., for PQC/Post-Quantum Crypto) can be used for seamless roaming, without defining seamless roaming-specific AKMs. In this case, an STA MLD, when performing authentication and association with the SMD-ME, selects an AKM from AKMs advertised by the AP MLD, which are not seamless roaming specific. In this case, the key management behavior for seamless roaming, indicating reuse of a single PTK across AP MLDs of an SMD, or generation of different PTKs for different AP MLDs of an SMD, or a hybrid mode (as described above), is indicated using one or more separate signaling fields as described below.

FIG. 5B depicts example formats of signaling seamless roaming key management modes using one or more separate fields, according to some embodiments of the present disclosure. An AP may advertise and signal fields indicating key management mode(s) for seamless roaming in the management frames it transmits, such as beacon frames, probe response frames, (re)association response frames, or other management or action frames. A STA MLD may select a roaming key hierarchy (single-PTK or different-PTK) based on the key management mode(s) advertised by the AP.

As depicted, a first example format 500B illustrates signaling of the seamless roaming key management mode within a Robust Security Network Extension Element (RSNXE). In this example, the key management mode may be indicated within the Extended RSN Capabilities field 525 of the RSNXE.

As depicted, a second example format 500C illustrates signaling of the seamless roaming key management mode within a Robust Security Network Element (RSNE), where the key management mode may be indicated within the RSN Capabilities field 530 of the RSNE.

As depicted, a third example format 500D illustrates signaling of the seamless roaming key management mode within a Seamless Mobility Domain (SMD) Information element, where the key management mode may be indicated within the SMD Capabilities field 535.

In the above-mentioned example formats 500B, 500C, and 500D, the field or fields used to indicate the seamless roaming key management mode may be one or more bits in length. Different seamless roaming key management modes may be indicated using different encoding mechanisms. For example, a single bit may be used to distinguish between two key management modes, including (i)reuse of a single PTK across AP MLDs of the SMD (i.e. using per SMD PTK) and (ii)generation of different PTK for each AP MLD (i.e. using per AP MLD PTK). Multiple bits may be used to encode three or more modes, or separate bits may be used to independently indicate support for a single-PTK mode, a different-PTK mode (per AP MLD), and a hybrid mode. Other encodings, including reserved or extensible values, may also be used. In some embodiments, the entire SMD supports a single key management mode for the seamless roaming, and this mode is advertised by all AP MLDs in the SMD using one of the signaling schemes described in FIG. 5B. For example, in one deployment, the SMD may support a single PTK across all AP MLDs. In another deployment, an SMD may support different PTKs for each AP MLD in the SMD.

The AP MLDs or SMD-ME of an SMD may signal their supported seamless roaming AKMs and (when applicable) supported seamless roaming key management modes using the fields illustrated in FIG. 5B. Such signaling may be included in one or more management frames, such as beacon frames, probe response frames, (re)association response frames, or other broadcast or unicast management frames. A STA or non-AP MLD may signal its supported seamless roaming AKMs and supported seamless roaming key management modes in one or more management frames, such as (re)association request frames or any other individually addressed management frames.

In some embodiments, only a single AKM suite is defined for seamless roaming. In such configurations, the authentication algorithm to be used for seamless roaming is selected during an Extensible Authentication Protocol (EAP) authentication exchange between an IEEE 802.1X supplicant and an IEEE 802.1X authentication server. When SAE or PSK authentication is selected between the supplicant and the authentication server, the supplicant and the authenticator perform client authentication using the selected authentication scheme in accordance with procedures already defined in the IEEE 802.11 standard. As in the embodiments described with reference to FIGS. 5A and 5B, signaling of different seamless roaming key management modes, including reuse of a single PTK, generation of different PTKs, or a hybrid mode, may be provided through one or more fields carried in an RSNE, an RSNXE, an SMD Information (Info) Element, or any other management elements.

In some embodiments, seamless roaming within an SMD is supported using existing AKM suites defined in the IEEE 802.11 standard that are related to non-FT AKMs for IEEE 802.1X, SAE, and PSK authentication. In such configurations, the seamless roaming key management modes are signaled separately from the AKM selection using one or more fields included in an RSNE, an RSNXE, an SMD Info Element, or any other existing or newly defined management elements. The authentication frames exchanged for seamless roaming authentication may further include SMD-specific information (e.g., an SMD Info element carrying an SMD identifier or SMD media access control (MAC) address) to associate the authentication exchange with a specific SMD. Based on the seamless roaming key management mode supported by both the STA and the AP MLD, the appropriate set of keys is generated by the STA and the AP MLD for use during roaming within the SMD.

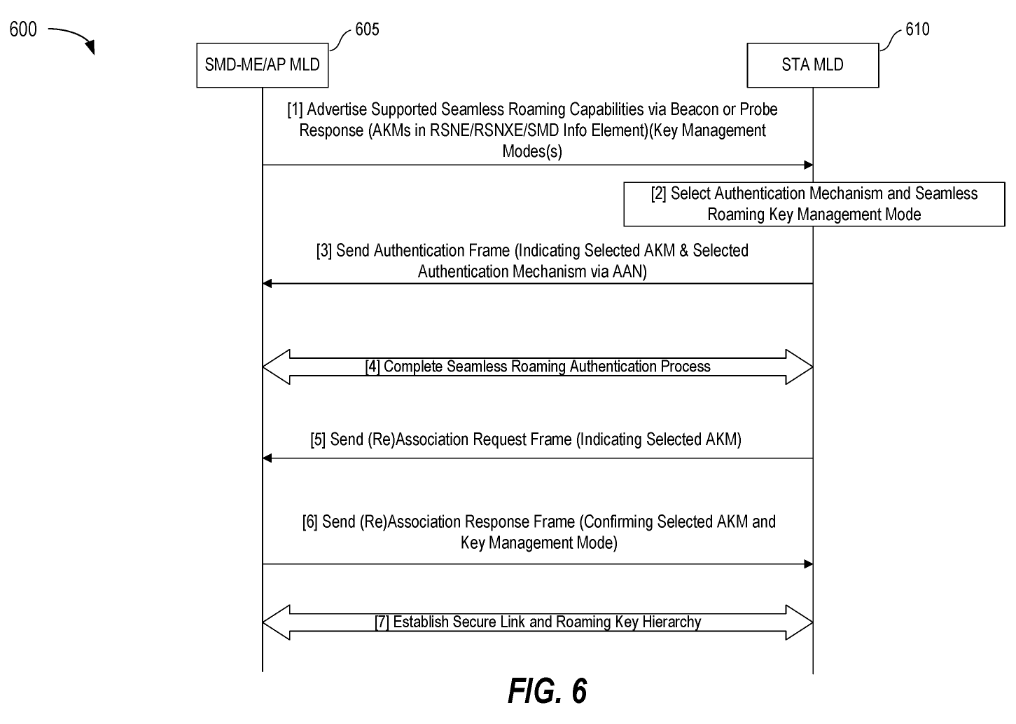

FIG. 6 depicts an example sequence 600 of interactions and management frame exchanges between an STA MLD 610 and an AP MLD (or an SMD-ME) 605 for negotiating seamless roaming authentication and key management behavior. The illustrated sequence is provided for conceptual clarity and may be modified or reordered in various implementations.

As depicted, in step 1, the AP MLD (e.g., 120 in FIG. 1) or SMD-ME (e.g., 115 in FIG. 1) advertises its supported seamless roaming capabilities. The advertised information may include one or more AKM suites supported for seamless roaming and, in some embodiments, one or more seamless roaming key management mode indicators (e.g., one or more bits used to indicate a single-PTK mode, a different-PTK mode, a hybrid mode). In one embodiment, the advertised information may indicate that only a single seamless roaming key management mode is supported by the AP MLDs in the SMD. Such information may be included in one or more management frames, including beacon frames, probe response frames, or other broadcast or unicast management frames. The AKM suites and/or key management indicators may be carried in an RSNE, an RSNXE, an SMD Info element, or any other elements defined to carry security parameters. In some embodiments, the AKM suites are defined for a newly created AAN corresponding to seamless roaming (e.g., ANN = <value N> as depicted in FIG. 2). In some embodiments, the AKM suites are defined for use with existing AANs. In some embodiments, the advertised AKM suites explicitly indicate both an authentication type and a seamless roaming key management mode, such as reuse of a single PTK or generation of different PTKs (as depicted in FIG. 3). In some embodiments, the advertised AKM suites indicate only an authentication type (as depicted in FIG. 5A), and the specific seamless roaming key management mode is indicated using one or more separate signaling fields (as depicted in FIG. 5B).

In step 2, the STA MLD (e.g., 125 in FIG. 1) receives the advertised seamless roaming capabilities and compares the advertised authentication and key management options with its own supported capabilities. Based on this comparison, the STA determines a set of authentication mechanisms and seamless roaming key management modes supported by both the STA and the network. The STA then selects an authentication mechanism and a seamless roaming key management mode from the determined set.

In step 3, the STA MLD transmits an authentication frame to the AP MLD or SMD-ME. The authentication frame indicates the selected authentication mechanism and the selected AKM. In some embodiments, the authentication frames include a newly defined AAN corresponding to seamless roaming authentication (e.g., AAN = <value N> as depicted in FIG. 2). In some embodiments, an existing AAN is used. The authentication frame may further include SMD-specific information, such as an SMD identifier or SMD MAC address in an SMD Info element, to associate the authentication exchange with a specific SMD.

In step 4 (as depicted conceptually using a bidirectional indication), the STA MLD and the AP MLD or SMD-ME complete the seamless roaming authentication process. At this stage, both parties have a shared understanding of the authentication context associated with the SMD.

In step 5, the STA MLD transmits an association or reassociation request frame to the AP MLD. The association request frame includes information identifying the selected authentication and key management option. In embodiments where AKM suites explicitly encode seamless roaming key management behavior (including authentication type and key management mode), the association request includes the selected AKM suite using an RSNE, RSNXE, SMD Info Element, or any other management elements.

In embodiments where the selected AKM suite broadly indicates a corresponding authentication type without revealing a specific key management mode, the STA MLD may indicate the selected seamless roaming key management mode via one or more key management mode fields within the (re)association request frame. The indicated mode may specify reuse of a single PTK, generation of different PTKs for different AP MLDs, or a hybrid mode permitting either generation of different PTKs or reuse of a previously established PTK during roaming. The key management mode indicator may be carried in one or more fields included in an RSNE, an RSNXE, an SMD Info Element, or another management element, and may be transmitted as part of the association request frame or in a separate management frame.

In step 6, the AP MLD or SMD-ME transmits an association or reassociation response frame confirming the association. The response may acknowledge the selected AKM suite and the selected seamless roaming key management mode.

In step 7 (depicted conceptually using a bidirectional indication), the STA MLD and the AP MLD or SMD-ME establish a secure communication link and a roaming key hierarchy based on the negotiated authentication mechanism and seamless roaming key management mode. The established roaming key hierarchy controls the generation, reuse, and rekeying of PTKs as the STA roams among AP MLDs within the SMD. Within the same SMD, there is no need for reassociation or reauthentication for subsequent transitions.

The interaction sequence depicted in FIG. 6 enables flexible negotiation of seamless roaming authentication and key management behavior across a wide range of implementation scenarios, including embodiments using newly defined AANs and AKM suites, embodiments using a reduced set of AKM suites with field-based signaling, and embodiments reusing existing AKM suites or existing authentication and key management mechanisms defined in the IEEE 802.11 standard.

In some embodiments, selection of the seamless roaming authentication mechanism and key management mode may be performed by the AP MLD or SMD-ME instead of by the STA MLD. In such embodiments, the STA MLD advertises its supported authentication types, AKM suites, and supported seamless roaming key management modes in one or more management frames, such as a (re)association request frame, a beacon frame, or a probe request frame. Based on the capabilities advertised by the STA MLD and the capabilities supported by the AP MLD or SMD-ME, the AP MLD or SMD-ME determines and selects an authentication mechanism and a seamless roaming key management mode that are supported by both parties. The AP MLD or SMD-ME then signals the selected authentication mechanism and key management mode to the STA MLD, for example, in an authentication frame, a (re)association response frame, or any other management frame. The STA MLD and the AP MLD (or SMD-ME) then complete authentication using the selected authentication mechanism and establish a roaming key hierarchy in accordance with the selected seamless roaming key management mode for use as the STA roams within the SMD.

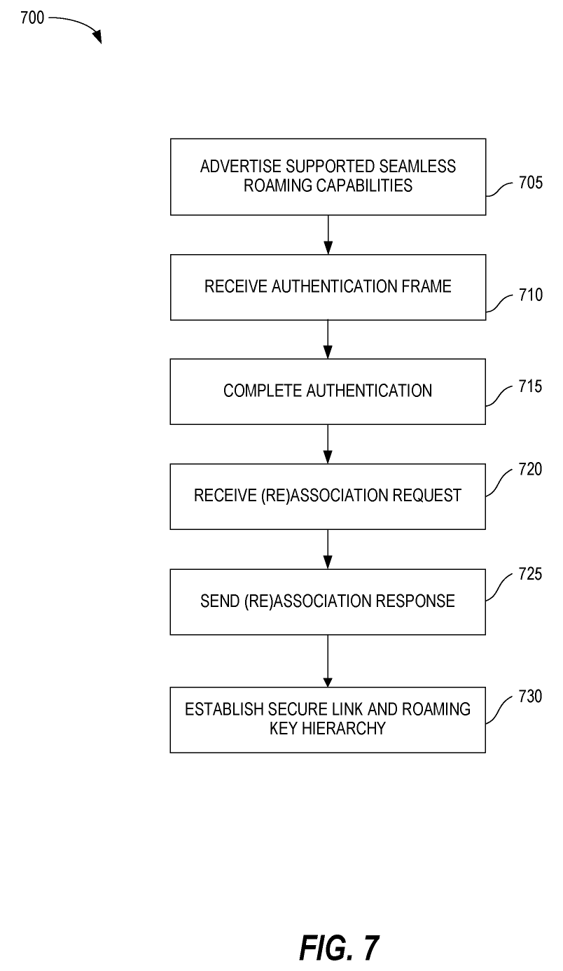

FIG. 7 depicts an example method 700 for negotiating seamless roaming authentication and key management behavior within an SMD, according to some embodiments of the present disclosure. The example method 700 may be performed by an AP MLD, an SMD-ME, or any other network devices configured to manage authentication and key coordination within an SMD.

At block 705, an AP MLD advertises supported seamless roaming capabilities. The advertised capabilities may include one or more AKM suites supported for seamless roaming and, in some embodiments, one or more key management indicators. The AKM suites may be defined for a newly defined AAN corresponding to seamless roaming or may be defined for use with existing AANs. The advertised information may be included in one or more management frames, such as beacon frames, probe response frames, or other broadcast or unicast management frames. In one embodiment, the advertised information may include one or more seamless roaming key management mode indicators (e.g., one or more bits used to indicate a single-PTK mode, a different-PTK mode, a hybrid mode). In another embodiment, the advertised information may indicate that only a single seamless roaming key management mode is supported by the AP MLDs in the SMD (e.g. indicate either a single-PTK mode or a different-PTK mode).

At block 710, the AP MLD receives an authentication frame from an STA. The authentication frame indicates the selected seamless roaming authentication mechanism (e.g., IEEE 802.1X authentication, SAE authentication, or PSK authentication) and the selected AKM. In some embodiments, the authentication frame includes a newly defined AAN specifically for seamless roaming (e.g., AAN = <value N> as depicted in FIG. 2). In other embodiments, an existing AAN is used in the authentication frame. The authentication frame may further include SMD-related information (e.g., an SMD identifier or SMD MAC address in an SMD Info element) to associate the authentication exchange with a specific SMD.

At block 15, the AP MLD completes the seamless roaming authentication process with the STA. Upon completion of authentication, both the AP-side entity and the STA share a common authentication context associated with the SMD.

At block 720, the AP MLD receives an association or reassociation request frame from the STA. The association request frame includes information identifying a selected authentication and key management option. In embodiments where AKM suites explicitly encode seamless roaming key management behavior, the association request indicates a selected AKM suite. In embodiments where the AKM suite does not explicitly indicate a key management mode, the association request may identify only the authentication type, and the method proceeds to block 730.

In embodiments where the selected AKM suite only specifies an authentication type (as depicted in FIGS. 5A)),the AP MLD receives an additional indication of the selected seamless roaming key management option (e.g., via one or more key management mode fields) within the (re)association request frame. Such indication may specify reuse of a single PTK, generation of different PTKs for different AP MLDs, or a hybrid mode. The key management mode indication may be carried in one or more fields included in an RSNE, an RSNXE, an SME Info Element, or other relevant management elements. The information may be received as part of the association request frame or in a separate management frame.

At block 725, the AP MLD transmits an association or reassociation response frame confirming the association and the selected authentication and key management option.

At block 730, the AP MLD establishes one or more secure communication links and a roaming key hierarchy with the STA based on the negotiated authentication mechanism and seamless roaming key management mode. The established roaming key hierarchy defines how PTKs are generated, reused, or rekeyed as the STA roams among AP MLDs within the SMD.

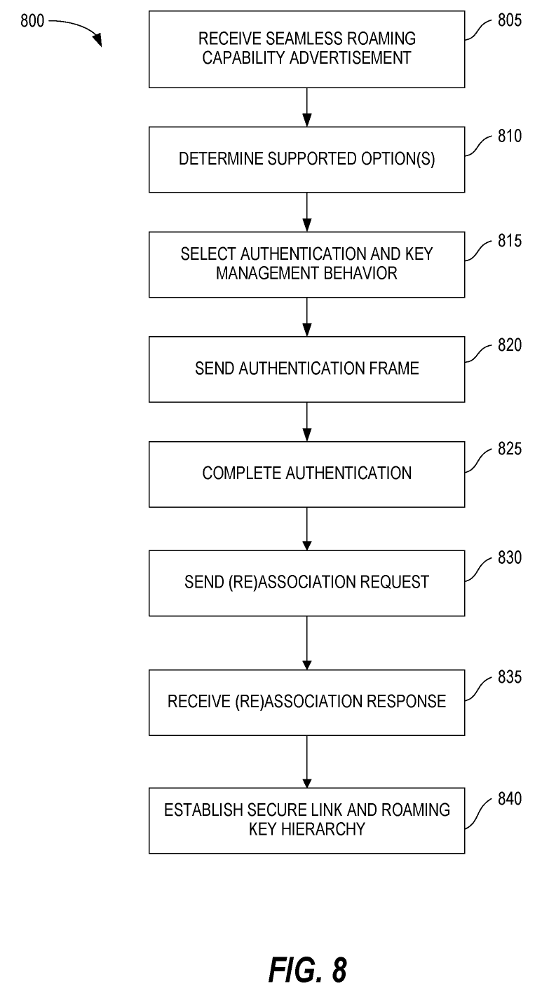

FIG. 8 depicts an example method 800 for negotiating seamless roaming authentication and key management behavior within an SMD, according to some embodiments of the present disclosure. The example method 800 may be performed by an STA MLD, a non-AP MLD, or any other client device configured to operate within an SMD.

At block 805, an STA MLD receives an advertisement of supported seamless roaming capabilities from the network. The advertised information may be transmitted by an AP MLD or an SMD-ME and may include one or more AKM suites supported for seamless roaming. The advertisement may be received via one or more management frames, such as beacon frames, probe response frames, or other broadcast or unicast management frames. The advertised information may be embedded within an RSNE, an RSNXE, an SMD Info Element, or any other management element. In one embodiment, the advertised information may include one or more seamless roaming key management mode indicators (e.g., one or more bits used to indicate a single-PTK mode, a different-PTK mode, or a hybrid mode). In another embodiment, the advertised information may indicate that only a single seamless roaming key management mode is supported by the AP MLDs in the SMD (e.g. indicate either a single-PTK mode or a different-PTK mode).

At block 810, the STA MLD determines authentication mechanisms (e.g., IEEE 802.1X authentication, SAE authentication, or PSK authentication) and seamless roaming key management modes (e.g., a single-PTK mode, different-PTK mode, or hybrid mode) supported by both the STA and the network. The determination may include comparing authentication types, AKM suites, and supported roaming key management behaviors advertised by the network with capabilities supported by the STA MLD.

At block 815, the STA MLD selects a seamless roaming authentication mechanism and a key management mode from the options supported by both the STA and the network. In some embodiments, the selected authentication mechanism corresponds to a newly defined AAN for seamless roaming.

At block 820, the STA MLD transmits an authentication frame to the AP MLD or SMD-ME. The authentication frame indicates the selected authentication mechanism, such as by including an AAN. The authentication frame may further include SMD-specific information, such as an SMD identifier or SMD MAC address.

At block 825, the STA MLD completes the seamless roaming authentication process with the network. Upon completion of authentication, the STA and the AP-side entity share a common authentication context associated with the SMD.

At block 830, the STA MLD transmits an association or reassociation request frame to the AP MLD or SMD-ME. The request may include information identifying a selected AKM suite.

In embodiments where the selected AKM suite does not explicitly indicate a seamless roaming key management option, the STA MLD includes one or more additional key management mode fields indicating the selected roaming key management mode. The indicated mode may specify reuse of a single PTK, generation of different PTKs, or a hybrid mode. The key management mode indication may be embedded in an RSNE, an RSNXE, an SMD Info Element, or any other management elements.

At block 835, the STA MLD receives an association or reassociation response frame from the AP MLD or SMD-ME, confirming the association and the selected authentication and key management option.

At block 840, the STA MLD establishes one or more secure communication links and a roaming key hierarchy with the AP MLD or SMD-ME based on the negotiated authentication mechanism and seamless roaming key management mode. The established roaming key hierarchy controls how PTKs are generated, reused, or rekeyed as the STA roams among the AP MLDs within the SMD.

The example methods depicted in FIGS. 7 and 8 illustrate embodiment where the STA compares supported seamless roaming capabilities and selects an appropriate option supported by both the STA and the network. In some embodiments, selection of the seamless roaming authentication mechanism and key management mode may be performed by the AP or SMD-ME. For example, the STA may advertise its supported roaming capabilities in a (re)association request frame. In response, the AP or SMD-ME may compare the advertised STA capabilities with its own supported capabilities, determine an appropriate authentication and key management mode supported by both parties, and indicate the selected option in a (re)association response frame or other management frames. The STA and the AP then establish a roaming key hierarchy following the selected roaming key management mode.

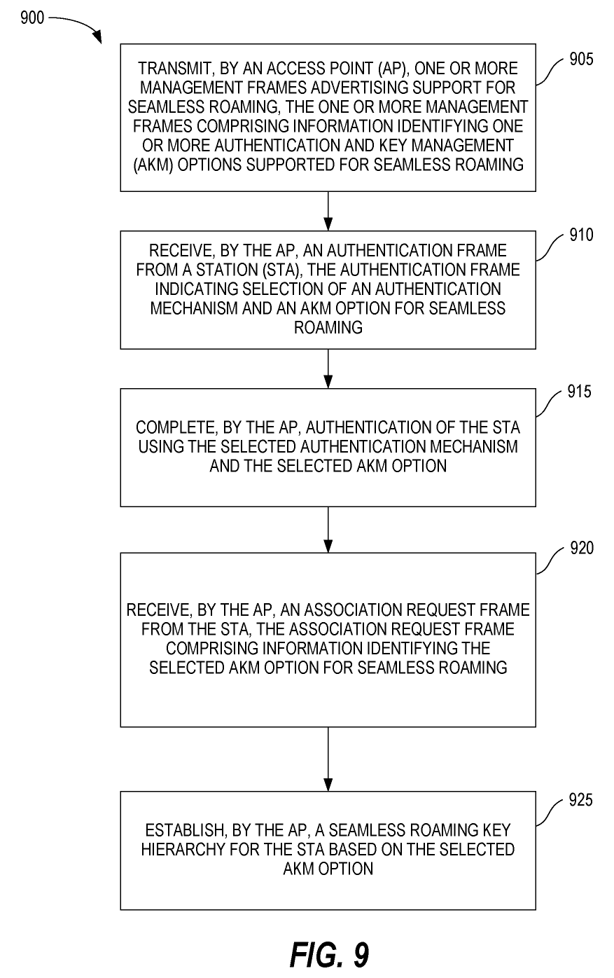

FIG. 9 is a block diagram depicting an example seamless roaming negotiation method 900, according to some embodiments of the present disclosure.

At block 905, an AP transmits one or more management frames advertising support for seamless roaming (as depicted by step 1 in FIG. 6), the one or more management frames comprising information identifying one or more authentication and key management (AKM) options supported for seamless roaming.

At block 910, the AP receives an authentication frame from a station (STA) (as depicted by step 3 in FIG. 6), the authentication frame indicating selection of an authentication mechanism and an AKM option for seamless roaming.

At block 915, the AP completes authentication of the STA using the selected authentication mechanism and the selected AKM option (as depicted by step 4 in FIG. 6).

At block 920, the AP receives an association request frame from the STA (as depicted by step 5 in FIG. 6), the association request frame comprising information identifying the selected AKM option for seamless roaming.

At block 925, the AP establishes a seamless roaming key hierarchy for the STA based on the selected AKM option (as depicted by step 7 in FIG. 6).

In some embodiments, the operation of advertising support for seamless roaming comprises advertising a key management mode field indicating whether a single-PTK mode or a different-PTK mode is supported for seamless roaming by the AP.

In some embodiments, the single-PTK mode specifies that a single PTK is used across one or more APs in a seamless mobility domain (SMD) for the STA.

In some embodiments, the different-PTK mode specifies that a different PTK is used for each AP in a seamless mobility domain (SMD) for the STA.

In some embodiments, the key management mode field is embedded within at least one of a Robust Security Network Element (RSNE), a Robust Security Network Extension Element (RSNXE), or a Seamless Mobility Domain (SMD) Information Element transmitted by the AP.

In some embodiments, the seamless roaming key hierarchy defines whether a single-PTK mode or a different-PTK mode is used as the STA roams from the AP to one or more other APs within a seamless mobility domain (SMD).

In some embodiments, the AP further establishes the seamless roaming key hierarchy based on one or more key management modes advertised by the AP. In response to determining that the advertised key management modes comprise a single-PTK mode, the AP implements the single-PTK mode in the SMD. In response to determining that the advertised key management modes comprise a different-PTK mode, the AP implements the different-PTK mode in the SMD.

In some embodiments, the authentication frame comprises a newly defined authentication algorithm number corresponding to the selected authentication mechanism (e.g., AAN = <value N> for seamless roaming as depicted in FIG. 2), and the selected AKM option corresponds to a new authentication and key management suite generated for the newly defined authentication algorithm number.

In some embodiments, the selected AKM option is selected from one or more authentication and key management suites defined under a predefined authentication algorithm number.

In some embodiments, the one or more authentication and key management suites comprise, for a respective authentication type, a first authentication and key management suite indicating support for a single-PTK mode, and a second authentication and key management suite indicating support for a different-PTK mode.

In some embodiments, the one or more authentication and key management suites comprise, for a respective authentication type, a first authentication and key management suite indicating support for both a single-PTK mode and a different-PTK mode for the respective authentication type.

In some embodiments, the association request frame or one or more other management frames comprises a key management mode field indicating whether a single-PTK or a different-PTK is selected by the STA under the respective authentication type.

In some embodiments, the selected AKM option corresponds to an existing authentication and key management suite defined under a predefined authentication algorithm number, and where the association request frame or one or more other management frames comprises a key management mode field indicating whether a single-PTK or a different-PTK is selected by the STA under a respective authentication type.

In some embodiments, the selected AKM option is determined by the STA based on a comparison of one or more AKM options supported by the STA with the one or more advertised AKM options by the AP.

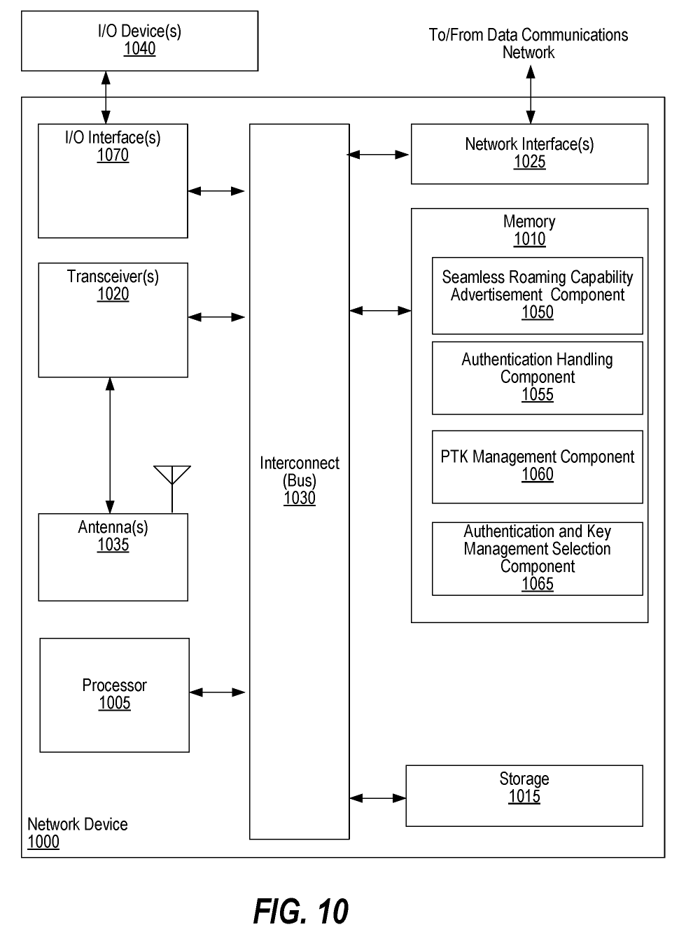

FIG. 10 depicts an example network device 1000 configured to perform various aspects of the present disclosure, according to some embodiments of the present disclosure. The network device 1000 may correspond to the AP MLD 120 or the SMD-ME 115 as depicted in FIG. 1, or any other network devices configured to manage authentication and key coordination within an SMD. In some embodiments, the network device 1000 may be implemented as a wireless local area network controller (WLC), a router, a gateway, a cloud-based network server, or any other computing device capable of performing seamless roaming authentication and key management negotiation as described herein.

As illustrated, the network device 1000 includes a processor 1005, memory 1010, storage 1015, one or more transceivers 1020, one or more I/O interfaces 1090, and one or more network interfaces 1025. In some embodiments, I/O devices 1040 are connected via the I/O interface(s) 1080. Further, via the network interface 1025, the network device 1000 can be communicatively coupled with one or more other devices and components (e.g., via a network, which may include the Internet, local network(s), and the like). Each of the components is communicatively coupled by one or more buses 1030. In some embodiments, one or more antennas 1035 may be coupled to the transceivers 1020 for transmitting and receiving wireless signals.

The processor 1005 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1005 processes information received through the transceiver 1020, I/O interfaces 1090, and the network interfaces 1025. The processor 1005 retrieves and executes programming instructions stored in memory 1010, as well as stores and retrieves application data residing in storage 1015.

The storage 1015 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1015 may store a variety of data for the efficient functioning of the system.

The memory 1010 may include random access memory (RAM) and read-only memory (ROM). The memory 1010 may store processor-executable software code containing instructions that, when executed by the processor 1005, enable the network device 1000 to perform various functions described herein for wireless communication.

As depicted, the memory 1010 includes a seamless roaming capability advertisement component 1050, an authentication handling component 1055, a PTK management component 1060, and an authentication and key management selection component 1065.

In one embodiment, the seamless roaming capability advertisement component 1050 is configured to advertise supported seamless roaming authentication mechanisms, AKM options, and supported roaming key management modes. Such advertisement may be included in beacon frames, probe response frames, (re)association response frames, or other management frames.

In one embodiment, the authentication handling component 1055 is configured to process authentication frames exchanged with a client device, including handling of newly defined AANs for seamless roaming or existing AANs defined in the IEEE 802.11 standard.

In one embodiment, the PTK management component 1060 is configured to establish and manage a roaming key hierarchy, including generation, reuse, and rekeying of PTKs. The PTK management component 1060 may support reuse of a single PTK across APs within an SMD, generation of different PTKs for different APs, or a hybrid mode permitting reuse of a previously established PTK during roaming, followed by generation of a new PTK for a target AP MLD after the transition.

In one embodiment, the authentication and key management selection component 1065 is configured to determine or select an authentication mechanism and a seamless roaming key management mode supported by both the network device and a client device. In some embodiments, the authentication and key management selection component 1065 evaluates authentication and key management options indicated by the STA and selects an appropriate option based on network capability and policy.

Although depicted as a discrete component for conceptual clarity, in some embodiments, the operations of the depicted components (and others not illustrated) may be combined or distributed across any number of components. Further, although depicted as software residing in memory 1010, in some embodiments, the operations of the depicted components (and others not illustrated) may be implemented using hardware, software, or a combination of hardware and software.

In some embodiments, the authentication and key management selection component 1065 may alternatively, or additionally, be included in an STA or non-AP MLD. In such embodiments, the STA performs a comparison of authentication mechanisms and seamless roaming key management modes supported by the STA and advertised by the network, selects an authentication mechanism and key management mode supported by both parties, and signals the selected option to the network device. The network device and the STA thereafter complete the authentication using the selected authentication mechanism and establish a roaming key hierarchy following the selected seamless roaming key management mode.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including elements A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
transmitting, by an access point (AP), one or more management frames advertising support for seamless roaming, the one or more management frames comprising information identifying one or more authentication and key management (AKM) options supported for seamless roaming;
receiving, by the AP, an authentication frame from a station (STA), the authentication frame indicating selection of an authentication mechanism and an AKM option for seamless roaming;
completing, by the AP, authentication of the STA using the selected authentication mechanism and the selected AKM option;
receiving, by the AP, an association request frame from the STA, the association request frame comprising information identifying the selected AKM option for seamless roaming; and
establishing, by the AP, a seamless roaming key hierarchy for the STA based on the selected AKM option.

2. The method of claim 1, wherein advertising support for seamless roaming comprises advertising a key management mode field indicating whether a single-PTK mode or a different-PTK mode is supported for seamless roaming by the AP.

3. The method of claim 2, wherein the single-PTK mode specifies that a single PTK is used across one or more APs in a seamless mobility domain (SMD) for the STA.

4. The method of claim 2, wherein the different-PTK mode specifies that a different PTK is used for each AP in a seamless mobility domain (SMD) for the STA.

5. The method of claim 2, wherein the key management mode field is embedded within at least one of a Robust Security Network Element (RSNE), a Robust Security Network Extension Element (RSNXE), or a Seamless Mobility Domain (SMD) Information Element transmitted by the AP.

6. The method of claim 1, wherein the seamless roaming key hierarchy defines whether a single-PTK mode or a different-PTK mode is used as the STA roams from the AP to one or more other APs within a seamless mobility domain (SMD).

7. The method of claim 6, further comprising establishing the seamless roaming key hierarchy based on one or more key management modes advertised by the AP, comprising:
in response to determining that the advertised key management modes comprise a single-PTK mode, implementing the single-PTK mode for the AP and other APs in the SMD, and
in response to determining that the advertised key management modes comprise a different-PTK mode, implementing the different-PTK mode for each AP in the SMD.

8. The method of claim 1, wherein the authentication frame comprises a newly defined authentication algorithm number corresponding to the selected authentication mechanism, and wherein the selected AKM option corresponds to a new authentication and key management suite generated for the newly defined authentication algorithm number.

9. The method of claim 1, wherein the selected AKM option is selected from one or more authentication and key management suites defined under a predefined authentication algorithm number.

10. The method of claim 9, wherein the one or more authentication and key management suites comprise, for a respective authentication type, a first authentication and key management suite indicating support for a single-PTK mode, and a second authentication and key management suite indicating support for a different-PTK mode.

11. The method of claim 9, wherein the one or more authentication and key management suites comprise, for a respective authentication type, a first authentication and key management suite indicating support for both a single-PTK mode and a different-PTK mode for the respective authentication type.

12. The method of claim 11, wherein the association request frame or one or more other management frames comprises a key management mode field indicating whether a single-PTK or a different-PTK is selected by the STA under the respective authentication type.

13. The method of claim 1, wherein the selected AKM option corresponds to an existing authentication and key management suite defined under a predefined authentication algorithm number, and wherein the association request frame or one or more other management frames comprises a key management mode field indicating whether a single-PTK or a different-PTK is selected by the STA under a respective authentication type.

14. The method of claim 1, wherein the selected AKM option is determined by the STA based on a comparison of one or more AKM options supported by the STA with the one or more advertised AKM options by the AP.

15. A system of an access point (AP), comprising:
one or more computer processors; and
one or more memories collectively containing one or more programs, which, when executed by the one or more computer processors, perform an operation, the operation comprising:
transmitting, by an access point (AP), one or more management frames advertising support for seamless roaming, the one or more management frames comprising information identifying one or more authentication and key management (AKM) options supported for seamless roaming;
receiving, by the AP, an authentication frame from a station (STA), the authentication frame indicating selection of an authentication mechanism and an AKM option for seamless roaming;
completing, by the AP, authentication of the STA using the selected authentication mechanism and the selected AKM option;
receiving, by the AP, an association request frame from the STA, the association request frame comprising information identifying the selected AKM option for seamless roaming; and
establishing, by the AP, a seamless roaming key hierarchy for the STA based on the selected AKM option.

16. The system of claim 15, wherein advertising support for seamless roaming comprises advertising a key management mode field indicating whether a single-PTK mode or a different-PTK mode is supported for seamless roaming by the AP.

17. The system of claim 16, wherein the single-PTK mode specifies that a single PTK is used across one or more APs in a seamless mobility domain (SMD) for the STA, and wherein the different-PTK mode specifies that a different PTK is used for each AP in the SMD for the STA.

18. The system of claim 16, wherein the key management mode field is embedded within at least one of a Robust Security Network Element (RSNE), a Robust Security Network Extension Element (RSNXE), or a Seamless Mobility Domain (SMD) Information Element transmitted by the AP.

19. The system of claim 15, wherein the authentication frame comprises a newly defined authentication algorithm number corresponding to the selected authentication mechanism, and wherein the selected AKM option corresponds to a new authentication and key management suite generated for the newly defined authentication algorithm number.

20. A computer program product comprising one or more computer-readable storage media collectively containing computer-readable program code that, when executed by operation of one or more computer processors, performs an operation comprising:
transmitting, by an access point (AP), one or more management frames advertising support for seamless roaming, the one or more management frames comprising information identifying one or more authentication and key management (AKM) options supported for seamless roaming;
receiving, by the AP, an authentication frame from a station (STA), the authentication frame indicating selection of an authentication mechanism and an AKM option for seamless roaming;
completing, by the AP, authentication of the STA using the selected authentication mechanism and the selected AKM option;
receiving, by the AP, an association request frame from the STA, the association request frame comprising information identifying the selected AKM option for seamless roaming; and
establishing, by the AP, a seamless roaming key hierarchy for the STA based on the selected AKM option.
